(19) United States
(12) Patent Application Publication
(10) Pub. No.: US 2003/0081430 A1
(43) Pub. Date: May 1, 2003

(54) L.E.D. curing light for dental composite

(76) Inventor: William Becker, Roxbury, CT (US)

Correspondence Address: Levisohn, Lerner, Berger & Langsam, 757 Third Avenue - Suite 2500, New York, NY, 10017, US

(21) Appl. No.: 10/021,182

(22) Filed: Oct. 30, 2001

(51) Int. Cl. A61C 3/00

(52) U.S. Cl. 362/573; 433/29

(57) ABSTRACT

An LED light curing probe is preferably integrated for use with a hose for a fiber optic dental handpiece of a dental unit. The integrated probe emits focused blue light as a consequence of the use of a lens located between the LED array and the end of the fiber optic light guide. The use of a heat sink and the drive air and exhaust air of the dental hose serves to facilitate removal of heat generated by the array of diodes. The LED light curing probe is swivable on the coupling of the dental hose.

### FIELD OF INVENTION

The invention generally relates to a fiber optic dental handpiece for curing dental composite. More specifically, the invention relates to a light emitting diode (hereinafter “LED”) dental handpiece for use in curing dental composites with a mechanism and structure for cooling of the LED array, designed to be quickly and easily removably connected to a dental hose (having channels and passageways for drive air and exhaust air, water, electric power and, optionally, chip air) in a dental unit.

### BACKGROUND OF THE INVENTION

Dental composite material is becoming increasing useful in the treatment and care of patients. Many different curing light designs have been sold over the past 20 or so years. The first of these is believed to have been an ultra-violet source used with the first dental restorative materials. The reason for using UV is that light in that portion of the wavelength spectrum has substantial energy. The energy of light is simply a constant value (Planck's Constant) multiplied by the light wavelength. The composite materials required a sufficient light source because they needed to absorb a level of energy high enough to initiate molecular restructuring (i.e., curing of the dental composite material). However, UV light was also considered an unnecessary risk because of its energy. Therefore, dental composite materials quickly changed to a lesser energy curing wavelength. The dental composite industry has basically stayed with this concept since its initial appreciation of the dangers and risks of UV light. Thus, today, it is believed that the ideal wavelength for a dental curing light is in the range of about 470 nanometers. All of today's curing lights for dental composites are in that range and have been designed to maximize output of this color light. The curing devices available to the dentist today utilize a variety of sources for the light, including halogen, plasma arc, laser, LED and combinations of these. However, it is believed that only LED and laser emit the ideal light. Laser is, however, relatively expensive and up until just recently, LED's were not considered bright enough for effective curing of dental composites. Brightness, of course, affects energy transfer and that, relatedly, impacts on the time for curing the composite. A composite is desired with a curing light which will allow the composite to cure rapidly (to minimize patient sitting time in the dental chair and the dentist's time awaiting curing). Today, extremely bright blue LED's are available which provide the wavelength and intensity for quickly and efficiently curing the dental composites.

There are basically two design considerations in using high brightness LED for dental curing. First, the LED is, after all, a diode. A diode has an electrical resistance associated with its junction materials that will produce heat relative to the quantity of current being supplied to the LED. With high current and multiple LED's in the curing array (commercially available curing light sources have a range of between 7 and 63 blue LEDs in the array) the light source can reach a high temperature quite quickly. Some mechanism to manage this heat is desired. Since the light curing device is hand held by the dentist and adjacent to the patient, during use, a mechanism which allows the blue LED array to provide the light for curing dental composite material is desirable and, yet, the dental curing light device must be maintained at a low enough temperature such that dentists can hold the device in their hand for extended periods of time without discomfort and the exterior of the device must not get too hot so that it can injure the patient if it inadvertently contacts the patient. The second basic consideration in design of a light curing device is that an array of LEDs, while clearly less expensive than laser light, does not produce coherent light like a laser. That is, the photon emission is not in a parallel well-defined beam. While it may not be necessary to utilize all of the light emitted by the LED array, to effectively cure dental composite in an efficient manner, it seems valuable to attempt to limit light and energy loss that could otherwise be used for the particular application.

From a clinical standpoint, today, an overwhelming majority of dentists are believed to perform some kind of light curing procedure on at least some of their patients. Indeed, many dentists are performing light curing procedures with dental composite materials on almost a daily basis. In many dental offices, because of the nature of the dental practice today and the associated economics, there are multiple operatories (dental chair-equipped rooms) each of which may require access to a curing light for the possibility of light curing of dental composites. Traditionally, many dentists buy one or two curing light devices and transport them wherever needed, i.e., to the operatories, as needed. This may economical but it may also be due to the fact that currently available light curing devices have been designed and marketed to emphasize portability. However, in view of the increased use of dental composite materials and the increase in operatories, there seems a need if not a parallel and competitive market, for curing lights to be quickly and easily available in all operatories as an integral component to the dental unit (dental chair and dental handpieces with appropriate tubing carrying passageways for the dental handpiece, e.g., drive air, exhaust air, water, chip air and electric wiring for powering a fiber optic dental handpiece lighting mechanism). The inventor believes that each and every operatory should be equipped with a curing light since the procedure of using dental composites may become the standard of care for dentists to provide treatment to patients.

Dentists that already specialize in composite restorations desire features that the occasional user may dismiss as seemingly unimportant. Since several teeth can be involved in some procedures, a mechanism to rotate the tip of the curing light, as can now be done with a dental handpiece, is very convenient. Also, if procedures are performed often, autoclavability may be highly desirable, if not critical.

Thus, a dental curing light which can be integrated into the existing dental units, powered by the standard hoses or an OEM unique hose, is desirable. The ability to cool the curing light also seems desirable since an array of LED blue lights seems economical in comparison to a laser light. Further an ability to focus the light so as to maximize the light emitted by the array and to direct the same to the patient is highly desirable. Also, the ability of the dental curing light source to attach and detach quickly and easily from the electric source seems desirable for sterility purposes. These and other considerations have been considered by the inventor and the present invention accomplishes these desired design goals.

Light curing of dental composite material is relatively a simple procedure. The science and expertise is in the materials themselves and the experience and knowledge of the dentist in preparing and using the material. Once the composite material is in place within the patient's oral cavity, the dentist only needs to expose it to the curing light for an adequate time. Many dentists cure the composite for two to three times the recommended curing time of the composite manufacturer, just to ensure curing. Yet, many curing light devices today appear relatively complicated and have apparently unnecessary operational parameters that seem to exist solely for marketing and/or for the purpose of increasing the cost (and thus profit margin) of the manufacturers.

To the inventor's knowledge, the currently commercially-available LED curing lights for dental composite material are battery operated with portability and “cordless operation” the design focus. The devices generally include LED arrays ranging from about 7 to 63 LEDs. None of the units, to the inventor's knowledge, have been designed to connect to the dental unit. The present invention contemplates that the light curing probe be in the nature of a separate dental handpiece-like device, i.e., capable of easily and quickly connecting to and being removed from the dental hose extending from the dental unit. This will provide various advantages as, for example, allowing a curing light to be present in each operatory without the necessity of transporting the electrical powering mechanism for the light to the operatory; allowing the light curing probe to be physically separated from the electric power supply for sterilizing purposes; making the LED light curing probes more easily and quickly available to the extent they are integrated, both physically and psychologically in the dentist's mind, with the dental unit, etc. Further, by providing an LED light curing device attachable to the dental hose of a dental unit, the drive air used for powering the dental handpiece (now removed and selectively replaced by the LED light curing probe, can be used for cooling the probe. These and other advantages are achieved by the present invention.

Thus, the present invention is specifically designed to be utilized with the dental unit rather than as the prior art, a stand-alone curing device. In so doing, every operatory can be economically and easily equipped with the necessary tool for light curing and, by so doing, the light curing task and its associated power components are integrated with the handpiece lighting and powering system. To effectively accomplish the goals of the present invention, then, the LED light curing probe should be capable of being handled by the dentist and constructed as much like a dental handpiece (with which dentists are quite familiar) as possible.

The present invention provides positive or forced cooling of the LED array. Lack of adequate cooling is not only deleterious to the life of the LEDs but, as mentioned, can impact on the dentists comfort level in using the light curing probe and/or the patient. The present invention also provides a lens system for gathering and focusing otherwise wasted light of the LED array. This, too, distinguishes the present invention from the known prior art. The lens system should result in more efficient use of the light curing probe, possibly leading to energy efficiency, i.e., lower power consumption of the LED array and/or decreased curing times. The present invention is attachable to the dental unit. Alternatively, of course, the technology and benefits of the present invention can be incorporated into a stand-alone unit but the preferred embodiment now contemplated envisions the integration of the LED light curing probe into the available dental units in dentist operatories. The advantages inherent in such an integration have been discussed above and ought to be readily understood and appreciated by those of ordinary skill in the art. The integration of LED light curing probe into dental unit provides a synergistic or multi-functional capability of light curing and handpiece lighting. The power supply for the handpiece lighting can be modified to permit the dental handpiece to be illuminated and the same power supply for the light source (a halogen bulb is generally used in today's fiber optic dental handpiece illumination systems) can be employed for the LED array of the curing device. The connection or proximal end of the new LED light curing probe, disclosed herein, can either be configured to a standard ISO-C standard, for example, or some other OEM-unique configuration. These and other advantages can be appreciated and achieved by the present invention.

Various LED light sources as a means for curing dental composite materials are known in the art. While extremely bright-blue LED's have recently emerged as the preferable light source for curing composite material, there is a need for greater integration of such devices within the dental office. Such LED light sources typically are powered by an energy source independent of the dental unit so as to enable easy transport between operatories. Furthermore, the diode(s) of the high energy blue light is prone to expending relatively large amounts of heat, potentially causing a significant reduction in the life of the product. This can also lead to discomfort to the dentist and/or patient during long-time use of the curing light device. While heat sink mechanisms have been provided behind the blue LED light of available dental curing devices, a mechanism for forced cooling of the array of diodes would be preferable as a means for prolonging the life of the LEDs. Finally, during routine dental procedures using the light curing device, the light emitted by the LED array is typically scattered, resulting in wasted energy as well as an increase in composite curing time. Thus there is a need in the field for a means of focusing the scattered light emitted by the LED onto the desired curing region.

U.S. Pat. No. 4,334,863 to Magid and Becker shows a dental handpiece, i.e., a dentist's airdriven drill, with a halogen bulb located adjacent to a fiber optic bundle for transmitting the light generated by the bulb to the patient's mouth. The '863 patent is directed to a mechanism for allowing the bulb to reach operating temperature and, yet, excessive heat is removed from the handle. This is accomplished by the use of the drive air, the exhaust air, a heat sink and air gaps. There is no teaching in the '863 patent of a device for curing dental composite which uses an LED array, nor providing any dental curing light as an attachment to the existing dental handpiece hose. Further the '863 patent neither teaches nor suggests the necessity of cooling the LED array of a dental device for curing composite material nor a lens for capturing and focusing the LED array and directing the same to the fiber optic light guide. These and other aspects are taught by the present invention.

### SUMMARY OF THE INVENTION

It is an object of the present invention to provide a blue LED light curing device which is integrated with a dental unit and provides for forced cooling of the array of diodes.

It is another object of the present invention to provide a curing device which uses a lensing system in order to gather and focus otherwise wasted light.

It is another object of the present invention to provide for a blue LED light curing device which is integrated with the dental unit and yet is easily removable and may be placed in an autoclave for sterilization purposes.

It is a further object of the present invention to provide for a probe-styled blue LED array, light curing device with a rotatable tip for easily directing the curing light at multiple desired locations.

In accordance with a preferred embodiment of the invention, a blue light LED array, composite curing device is provided, preferably with a probe shaped fiber optic tip for directing the light to its desired location. The LED light curing device is integrated with a dental unit. The present invention derives the power for the LED array from a direct electrical and mechanical connection to the coupler mechanism at the end of a dental unit hose, now available for securing and powering fiber optic dental handpieces. During use, the LED light curing device generates heat. Yet, the design and mechanical construction of the present invention is such that an uncomfortable, excessive temperature rises at the exterior thereof is reduced and believed eliminated. This maintains the device comfortable to use, even for long periods of time, by the dentist and is safe for the patient. Air entrance and exit passages are located at the base of the LED dental curing light and preferably conform to the ISO standard configurations for dental handpieces and dental units. As the blue LED diodes emit heat, air is powered and delivered through the air entrance passage and will come into contact with the back of the diodes. The drive air for the otherwise available dental handpiece is used as the transfer medium for the heat generated by the LED array. The heat is carried away by the air as it is removed through the exhaust air passageway (also present in the handpiece coupler to which the light curing probe is now attached in lieu of the dental handpiece). The cooling of the LED curing light probe is enhanced by the use of an aluminum heat sink for the generated heat, which heat sink surrounds the LED array for heat absorbing and, yet, is in direct contact with the drive air for heat transfer.

A further embodiment of the present invention includes the addition of a focusing lense as well as a probe-style light curing configuration with the means to selectivley rotate the head of the probe. Other objects, advantages and features of this invention will be become apparent herein after.

### BRIEF DESCRIPTION OF THE DRAWINGS

FIG. 1 is an exploded and cross-sectional, side view of the LED light curing probe of the present invention and

FIG. 2 is an assembled and cross-sectional, side view of the LED light curing probe of the present invention.

### DETAILED DESCRIPTION OF THE DRAWINGS AND PREFERRED EMBODIMENTS OF THE INVENTION

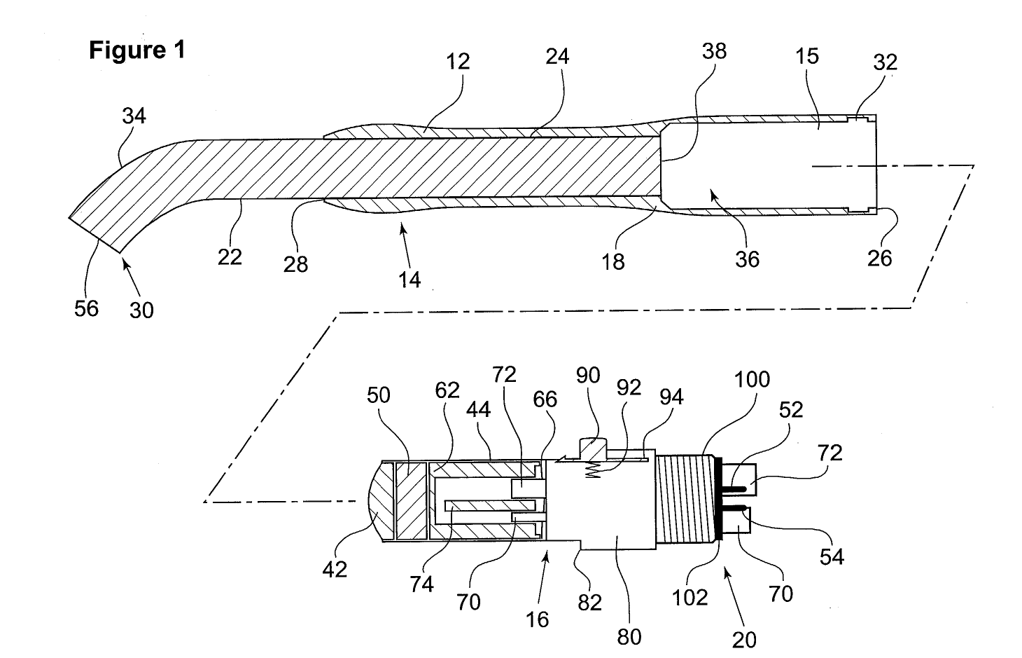

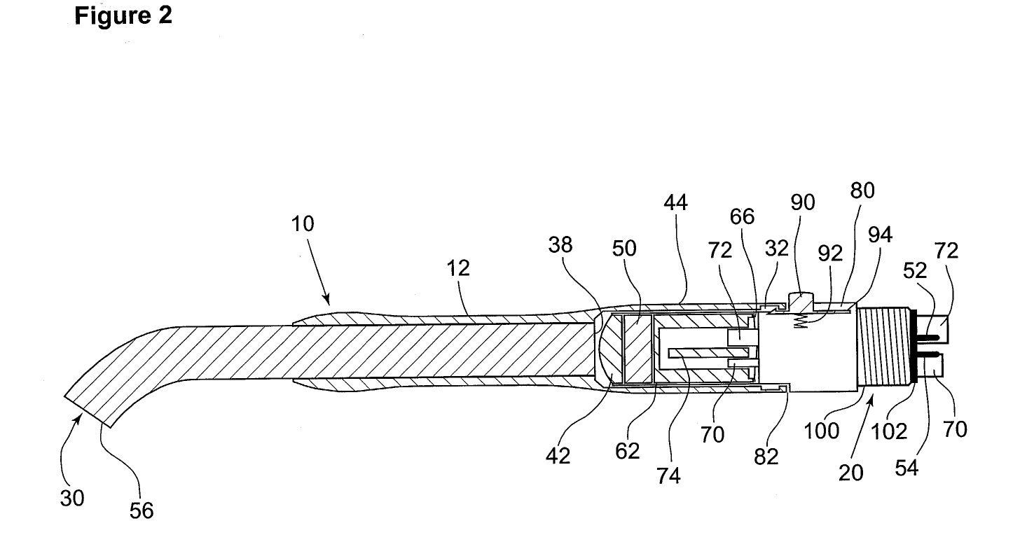

An LED light curing device for dental composite materials is shown in the Figures. Basically, the device has a configuration similar to that of a dental handpiece. The LED light curing device 10 is, preferably, securable to and detachable from a standard ISO configuration or OEM-unique hose (4 or 5 hole) otherwise useful for fiber optic dental handpieces having illumination means (generally halogen bulbs) in combination with fiber optic light guides within the handpieces. Preferably, the outside surface of the LED light curing device 10 is made of stainless steel for sterilization purposes. An exploded view of the device is shown in FIG. 1 whereas the assembled device, comprised of handle 14 and LED sub-assembly 16 is shown in FIG. 2. The LED light curing device is roughly cylindrical in shape with proximal and distal ends 20 and 30, respectively. Referring to FIG. 1, the dental LED light curing device 10 is comprised of two separable and attachable basic components, namely, the handle assembly 14 and the LED sub-assembly 16. Handle assembly 14 has a tubular handle 18, made from stainless steel (in the preferred embodiment) and a fused, cellular fiber optic light guide 22. The handle 18 is tubular in shape and of an external diameter such that it is comfortably held in the dentist's hand. The stainless steel exterior surface 12 is desirable for both sterilization and lightweight. The handle 18 is hollow, as a consequence of a central bore 24 passing longitudinally there through from its proximal end 26 to its distal end 28. An annular swivel locking groove 32 is provided at the proximal end 26 of the handle 18. Its function will be more clearly understood after the other components of the device are described. The fused cellular fiber optic light guide 22 is secured, either frictionally and/or with bonding materials, within the bore 24 of the handle. The fiber optic light guide 22 extends beyond the distal end 28 of the handle 18 and preferably has a curved end 34 to facilitate focusing by the dentist on the work site (a tooth or teeth) sought to be provided with composite material for curing. The fiber optic light guide 22 does not extend entirely through the center bore 24 of the handle 18 (on the proximal side 26) but, rather, terminates at a distance from the proximal end 26 so that the handle 18 accommodates the LED sub-assembly 16 within the rear portion of the bore 24, with a short length of the LED sub-assembly 16 extending rearwardly from the handle's distal end 26 (as can be seen in FIGS. 1 and 2). A cavity 36 is defined in the rear or proximal end of the handle 18 by the rear end 38 of the fiber optic light guide 22 and the proximal end 26 of the handle. The LED subassembly 16 fits within cavity 36 such that its forward portion, a plano-convex lens 42 is closely adjacent the rear end 38 of the light guide 22. However, as mentioned, the proximal end 20 of the LED light curing device extends beyond the proximal end 26 of the handle 18.

The LED sub-assembly 16 is basically cylindrical in shape. Its outside diameter is slightly less than the inside diameter of the cavity 36 so that the handle assembly 14 can rotate about the longitudinal axis of the device 10, while the end of the LED sub-assembly is connected to the dental handpiece coupler of the dental unit hose (not shown). The LED sub-assembly casing 44 is manufactured from stainless steel. It is hollow and roughly cylindrical. The casing 44 secures, at its front end, the rear and one-side planar and leading, one-side convex lens 42. Behind the plano-convex lens 42 is the light emitting diode array 50. They are in light communication such that light emitted from the light emitting diode array 50 will be received by and focused by the plano-convex lens 42 to impact on the rear end 38 of the fiber optic light guide 22. The light emitting diode array 50 is preferably comprised of forty-eight LEDs, each of which provides bright blue light when electrically powered. Preferably the wavelength of the LEDs is set for about 470 nanometers. The LEDs of the light emitting diode array are connected together so that they are all powered by electrical leads 52 and 54 extending through the center of the casing 44 and terminating out of the proximal end 20 of the LED sub-assembly. The LEDs of the light emitting diode array 50 are basically uniformly spread over the round surface of the array such that a uniform blue light is emitted toward the rear of the plano-convex lens 42. There, as mentioned, the light is collected and focused by the lens configuration to provide focused light to the rear end 38 of the fiber optic light guide 22. When the light is emitted by the fiber optic light guide 22, at its flat forward tip 56, curing of the dental composite will occur, at least if dental composite is provided with the matching characteristics for curing as the light of the LED array 50 and so long as the proper amount of curing time is provided by the light.

An aluminum heat sink 60 is provided behind the LED array 50 and also housed within the casing 44. The aluminum heat sink is in the shape of a one end closed cylinder, like a thimble, with its flat end 62 closely adjacent to yet slightly separated from the rear of the LED array 50. As will be further explained, the heat sink 60 serves to collect heat generated from the LED array 50 and, with the passage of drive air over its interior and exterior surface, and the withdrawal of the now-slightly heated air through the exhaust air passageway, facilitates cooling of the device. The rear of the aluminum heat sink is provided with an annular raised leg 66 which isolates the aluminum heat sink 60 from the proximally located component. A pair of air passageways, preferably metal tubes, drive air providing passageway 70 and exhaust air passageway 72 (and chip air, too, if that is the configuration of the coupler for the dental hose) terminate into the interior cavity of the aluminum heat sink 60, a slight distance from the rear flat surface 62 of the heat sink 60. A diverter 74 is wedged between the distal ends of the air passageways 70 and 72 and extends toward the flat end surface or wall 62 of the heat sink 60. It, too, is separated from the flat surface 62 and forces the air to travel around it, putting the drive air (coming into the interior cavity of the heat sink by the air passageway 70) into contact with more surface area of the heat sink, before the air is exhausted from the device through the exhaust air passageway 72.

Located behind the aluminum heat sink 60, i.e., proximal with respect to the device, is a cylindrical member 80. Member 80 is made from stainless steel, too. Its outside diameter varies along its length such that the forward portion fits within the cavity 36 of the handle 18 and its rear section is surface contiguous with the outside diameter of the handle 18. Thus a shoulder 82 is formed and contacts the proximal end 26 of the handle 18, when the device is assembled. The cylindrical member 80 is provided with a positive mechanical connection button 90, spring biased outward by spring 92, which is held in a cylindrical recess 96 (not shown). The button is secured to a longitudinal plate 94, extending along the longitudinal axis of the device, for stability. The plate 94 is held within a suitably shaped recess (not shown) so as to allow the button and plate to radially reciprocate when the button is depressed and then let go. Depressing the button 90, against the force of the button, causes the plate to move radially inwardly and allows the locking tooth 98 (at the distal end of the plate 94) to move away from the annular, swivel locking groove 32. Removal of thumb pressure on the button 90 causes the spring bias of spring 92 to come into play and causes the plate 94 and the locking tooth 98 to move radially outwardly such that the locking tooth is captured by the annular, swivel locking groove 32. This secures the LED sub-assembly 16 to the handle assembly 14 and, yet, allows the handle 18 with fixed light guide 22 to rotate with respect thereto.

The rear end of the member 80 is provided with external screw threads 100 for mating engagement with internal screw threads of the hose nut (not shown) of the dental unit's hose assembly. The rear or proximal end of the screw threads, a flat surface, is preferably provided with a gasket 102, rubber or plastic, which mates with the coupling end of the hose of the dental unit. The gasket 102, of course, fits over the electrical connections 52 and 54 and the air passageways 70 and 72. With the multi-holed coupler of the hose of the dental unit secured to the rear of the member, such that the drive air passageway 70, the exhaust air passageway 72, the electrical connections 52 and 54 are in alignment with the corresponding holes of the coupler, the hose nut (part of the dental unit's hose assembly is moved forwardly or distally so that it fits over the screw threads and is threaded thereon. Now, a complete LED light curing device, connected to the dental unit's hose is provided.

With the LED light curing device 10 secured to the coupler of the dental hose, as described, and the hose nut secured to the threads 100, the device will operates as follows (at least when power is provided to the device by a suitable foot pedal, already conventional in connection with fiber optic dental handpieces for providing drive air and electrical power to a dental handpiece):

a) Electrical power is provided by the pair of electrical connections 52 and 54, through the member 80, to the LED array 50. The LED's are energized and emit a bright blue light of the appropriate wavelength. The emitted light is collected by the lens, focused by the convex surface, and transmitted to the rear end 38 of the fiber optic light guide. The light passes through the light guide 22 and is emitted out of the flat tip of the fiber optic light guide 56. There, of course, it is directed by the dentist onto composite material, laid onto a tooth, for curing the same.

b) The drive air of the dental unit will come into the device 10, through the drive air passageway 70, circulate around the diverter 74, and exit the device through the exhaust air passageway 72. During its passage through the device, air will absorb heat from the aluminum heat sink 60 and take the heat away from the device thereby maintaining the device comfortable for the dentist and safe for the patient.

c) The heat generated by the LED array 50 will be absorbed by the aluminum heat sink 60 and, yet, the array will efficiently operate in that there is an air gap between the flat end 62 of the aluminum heat sink 60 and the rear of the light emitting diode array 50. There is also an air gap between the exterior surface of the aluminum heat sink 60 and the casing which serves to isolate the heat sink so that heat is not transferred to the casing then to the handle. This further ensures that the heat generated by the array 50 is absorbed by the air passing through the device and taken through the exhaust air passageway 72. According to one embodiment of the invention the heat sink is made from a material of relatively high thermal conductivity with the handle made from a material of relatively lower thermal conductivity. The two pieces, handle and heat sink are separated from one another by an air gap to isolate the heat sink from the handle.

d) The handle 18, with fiber optic light guide 22, is rotatable around the longitudinal axis of the device so that the dentist can easily aim the flat tip 56 of the light guide, as desired. The handle assembly 14 rotates around the casing of the LED assembly 16, while maintaining alignment between the lens 42 and the rear end 38 of the fiber optic light guide 22. The locking tooth 98 within the annular swivel locking groove permits the 360 degree swivel. The location of the cavity 36 of the handle assembly 14 over the outside cylindrical surface of the casing 44 maintains alignment.

e) When the device is desirably removed, as for example to sterilize the handle assembly, the button 90 is depressed against the bias of the spring 92. This causes the flat plate 94 to move radially inwardly which releases locking tooth 98 from the annular swivel locking groove 32. Then, the handle assembly 14 can be removed from the LED assembly 16. Replacement of a different or the sterilized handle assembly is accomplished by sliding the handle assembly over the locking tooth (which has an inclined surface to ease the relative movement) such that the locking tooth and plate are cammed radially inwardly until the locking tooth 98 is located within the annular swivel locking groove. Then, the locking tooth 98 and plate 94 will move radially outwardly, by the outward bias of the spring, into the position of the locking tooth within the annular swivel locking groove.

f) If desired, as when, for example to replace the entire LED light curing device (either with another one or to reuse the hose with a dental handpiece) or to remove the LED array 50 and/or the LED assembly, the hose nut can be unscrewed from the threads 100 and the hose nut retracted on the hose. Then, the coupler of the dental hose can be removed from the rear of the LED light curing device.

Having described the invention with respect to the drawings and the preferred embodiment, the scope of the invention is that set forth in the attached claims, as interpreted consistent herewith and by the Courts.

I claim as follows:

1. An LED curing device for dental composite comprising:
a) LED array means for generating light in a limited range of wavelength;
b) a fiber optic light guide for transmitting the light emitted by said LED array means, said light guide held in a handle;
c) and a lens interspersed between said LED array means and said fiber optic light guide for collecting said light emitted by said LED array means and focusing the same into said light guide.

2. A device as claimed in claim 1 wherein said lens is a plano-convex lens.

3. A device as claimed in claim 1 wherein said LED array means comprises about 48 LEDs, each capable of producing blue light.

4. A device as claimed in claim 3 wherein the wavelength of said light is about 470 nanometers.

5. A device as claimed in claim 1 further comprising a heat sink means for collecting and removing heat generated by said LED array means.

6. A device as claimed in claim 5 wherein said heat sink means comprises a block of heat absorbing material located proximal to said LED array means and a passageway of air for directing air across a surface of said block to remove heat absorbed thereby.

7. A device as claimed in claim 6 wherein said heat sink means is aluminum.

8. A device as claimed in claim 6 further comprising a passageway for exhausting air after it has been directed across said surface of said block.

9. A device as claimed in claim 8 further comprising a diverter means for air to ensure that air contacts said heat sink means before it is exhausted from said device.

10. A device as claimed in claim 1 having a dental unit connection means for providing electrical power to said LED array means.

11. A device as claimed in claim 10 wherein said dental unit connection means comprises a standard ISO male end for a dental handpiece.

12. A device as claimed in claim 10 wherein said dental unit connection means comprises a 4 or 5 hole OEM male configuration for a dental handpiece.

13. A device as claimed in claim 1 further comprising swivel connection means to enable said fiber optic light guide to swivel with respect to said LED array means.

14. A device as claimed in claim 13 wherein said swivel connection means comprises said fiber optic light guide being provided with an annular groove and said handle having a locking tooth which is captured by said annular groove.

15. A device as claimed in claim 5 further comprising an air gap between said heat sink means and said LED array means.

16. A device as claimed in claim 5 further comprising an air gap between said heat sink means and the exterior surface of said handle for said fiber optic light guide.

17. A hand held LED curing device for dental composite comprising:
a) a handle;
b) LED array means for generating light in a limited range of wavelength;
b) a fiber optic light guide located with one end adjacent to said LED array means for transmitting the light emitted by said LED array means, said light guide held in said handle;
c) and a heat sink means for collecting and removing heat generated by said LED array means.

18. A device as claimed in claim 17 wherein said heat sink means comprises a block of heat absorbing material located proximal to said LED array means and a passageway of air for directing air across a surface of said block to remove heat absorbed thereby.

19. A device as claimed in claim 17 wherein said heat sink means is aluminum.

20. A device as claimed in claim 18 further comprising a passageway for exhausting air after it has been directed across said surface of said block.

21. A device as claimed in claim 20 further comprising a diverter means for air to ensure that air contacts said heat sink means before it is exhausted from said device.

22. A device as claimed in claim 17 further comprising a lens for collecting and focusing said light from said LED array means.

23. A device as claimed in claim 17 having a dental unit connection means for providing electrical power to said LED array means.

24. A device as claimed in claim 23 wherein said dental unit connection means comprises a standard ISO male end for a dental handpiece.

25. A device as claimed in claim 23 wherein said dental unit connection means comprises a 4 or 5 hole OEM male configuration for a dental handpiece.

26. A device as claimed in claim 17 further comprising swivel connection means to enable said handle to swivel with respect to said LED array means.

27. A device as claimed in claim 26 wherein said swivel connection means comprises said fiber optic light guide being provided with an annular groove and said handle having a locking tooth which is captured by said annular groove.

28. A device as claimed in claim 17 further comprising an air gap between said heat sink means and said LED array means.

29. A device as claimed in claim 17 further comprising an air gap between said heat sink means and the exterior surface of said handle.

30. A device as claimed in claim 22 wherein said lens is a plano-convex lens.

31. A device as claimed in claim 17 wherein said LED array means comprises about 50 LEDs, each capable of producing blue light.

32. A device as claimed in claim 17 wherein the wavelength of said light is about 470 nanometers.

33. A device as claimed in claim 17 wherein said heat sink is made of a material of relative high thermal conductivity and said handle made from a material of relative low thermal conductivity and an air gap separates said heat sink and said handle.

34. A hand-held curing device for dental composite comprising:
a) a handle;
b) light means in said handle for generating light;
b) a fiber optic light guide secured to said handle with one end adjacent to said light means for transmitting the light emitted thereby to the other end of said fiber optic light guide;
c) and a coupling means for said handle to permit removable securement of the same to a standard ISO or OEM-unique dental handpiece hose.

35. A device as claimed in claim 34 wherein said light means is an LED array providing light within a limited range of wavelengths.

36. A device as claimed in claim 35 wherein said LED array comprises about 48 LEDs which emit blue light in the range of about 470 nanometers.

37. A device as claimed in claim 34 further comprising a collecting and focusing lens between said light means and said fiber optic light guide.

38. A device as claimed in claim 34 further comprising a heat sink means located near to said light means for absorbing the heat generated thereby and heat removal means for removing some of the heat from said heat sink means.

39. A device as claimed in claim 38 wherein said heat sink means comprises an aluminum block adjacent to said light means and said heat removal means comprises a stream of air passing across at least a surface of said aluminum block.

40. A device as claimed in claim 39 wherein said steam of air is provided by the drive air and exhaust air of said ISO standard or OEM-unique dental handpiece hose.

41. A device as claimed in claim 39 further comprising a deflector means for directing said air stream against more than one section of said aluminum block.

42. A device as claimed in claim 38 wherein an air gap is provided between said heat sink means and said light means.

43. A device as claimed in claim 42 further comprising a second air gap between said meat sink means and said handle.
